(19) United States
(12) Patent Application Publication
(10) Pub. No.: US 2009/0198483 A1
(43) Pub. Date: Aug. 6, 2009

(54) Apparatus and method for network emulation by using hardware accelerated network interface cards

(76) Inventor: Sezen Uysal, (US)

Correspondence Address: SEZEN UYSAL, 9318 KILBY GLEN DR., VIENNA, VA, 22182, US

(21) Appl. No.: 12/027,117

(22) Filed: Feb. 6, 2008

(51) Int. Cl. G06G 7/62

(52) U.S. Cl. 703/13

(57) ABSTRACT

This invention is an apparatus and a method to emulate packet networks at maximum network physical layer speeds by using hardware accelerated network interfaces cards (HANIC) in a host computer system. The system emulates packet network characteristics by introducing all possible impairments such as latency, packet loss, bandwidth throttling to packets traffic traversing the system. As the packet processing is mostly performed by the HANIC, packets can be processed and forwarded at theoretical maximum speed (wire speed) of the network connections.

### BACKGROUND OF INVENTION

Network emulation systems are used to create all possible network conditions and problems in a controlled laboratory environment for testing networking equipment or applications.

Traditionally network emulation is achieved by processing packets in a software application that runs on an operating systems. As packet reception and transmission are handled by the busy operating system, under heavy traffic the accuracy and performance of the network emulation system suffer. This is mostly because the traditional network interface cards and the operating system are not designed to handle small packets at high speeds.

On the other hand, implementing the network emulation in a hardware only solution which does not have a traditional operating system results in very limited network emulation features since the hardware only solution cannot implement some impairments that require complex packets processing such as various queuing methods, real-time packet modifications, changing the order of packets, etc.

This invention proposes a network emulation system that uses special network interface cards and a driver software in a traditional computer with an operating system. This invention can implement impairments at network wire speeds.

### SUMMARY OF INVENTION

An apparatus and a method for implementing wire speed network emulation by using special network interface cards are introduced. By using a computer system with fast I/O card interfaces such as PCI-X, PCI-E, or SPI and by using a hardware accelerated network interface card (HANIC), it is possible to process and forward packets at maximum theoretical throughput of network connections (also known as wire speed).

The network emulation system is computer with at least two network interfaces using HANIC. It receives network packets at one interface and applies network impairments such as latency, packet loss to them, and then forwards them to the other interface.

HANICs receive the packets without interacting the host system's operating systems' traditional packet reception programs. Similarly, packet transmission is achieved again bypassing operating system packet sending processes. Packet transmissions are scheduled to the previously computed “send time” of the packets.

As software operations on packet processing is minimized, wire speed on several fast networking technologies such as gigabit Ethernet, 10 Gigabit Ethernet, Sonet networks at OC-12 speeds can be achieved. The wire speed is defined as the maximum forwarding rate for smallest allowed packet size. For example, wire speed for gigabit Ethernet is 1.4 million packets per second for 64 byte Ethernet packets.

Impairment operations on the packets can be performed either on HANICs or an application which interacts with the HANIC driver software.

### BRIEF DESCRIPTION OF DRAWINGS

FIG. 1 shows one embodiment of the invention in which Ethernet packets from two networks are introduced network impairments by a Network Emulation System. In that system, there is one HANIC inserted in the PCI-E bus. The packets are stored in a DMA area of the system memory which is accessed by HANIC driver and the network emulation software running on the system processor.

### DETAILED DESCRIPTION

The invention allows performing network emulations at maximum network connection speeds (wire speeds) by using a computer system and special network interface cards. It uses a host computer with an operating system and fast I/O interfaces such as PCI-E slots and one or more HANICs connected in the PCI-E slots. As the system uses a generic computer, the solution is very scalable and cost effective.

In one embodiment, the HANIC is designed to connect computer systems' PCI-E slot. It contains a hardware logic to receive, transmit and process data packets at maximum media speeds with minimum impact on the computer system's operating system. The logic can be implemented on a Field Programmable Gate Array (FPGA), Application Specific Integrated Circuit (ASIC) or System on Chip (SOC).

The HANIC uses a special driver application that utilizes Direct Memory Access (DMA) method to store received packets. Since the HANIC does not create traditional interrupt driven network reception event in the operating system and it uses “zero copy” packet storing through the DMA, network emulation using HANICs creates minimum packet latency hence achieves the wire speed.

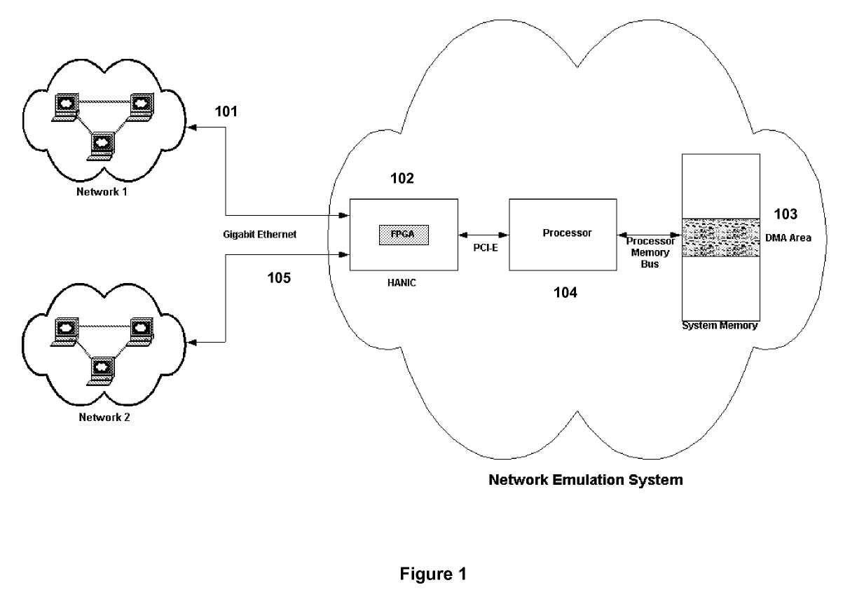

FIG. 1 shows one embodiment of the invention. This Network Emulation System uses a generic computer system and a single HANIC with FPGA logic and two gigabit Ethernet interfaces. On each interface a network of computers are connected. Packets from network 1 are received on one interfaces (101) and processed by the HANIC (102).

The HANIC, by using the driver application, moves the packets directly to the DMA area in the system memory without any memory copy operation (a.k.a zero copy) and with minimum impact on the operating system of the host computer, since it does not generate traditional packet interrupt events while receiving packets (103). The network emulation software running on one of the system processors accesses the packets through the HANIC driver functions and hardware registers (104). Network emulation software can implement network impairments by modifying packet contents, packets' send times, order of packets, or by marking them for packet drop.

Once the network emulation processing is over, network emulation software informs the HANIC for packet transmission. Then the HANIC access the DMA again and transfers the packets to network 2 through the other interface. Packet transmission is based on the send times of the packets and whether they need to be dropped or not (105). In other words, packets not marked as “drop it” is transmitted at exact time of their previously computed “send time”. Sent times are computed dynamically based on the system configuration defined by the user of the system.

In another embodiment of the invention, received packets can be stored in the HANIC. This can be achieved with additional fast memory installed directly on the HANIC. By performing network emulation functions on the FPGA or ASIC logic, packets would never cross the PCI-E bus. Only the control messages from the operating system or application user interfaces would traverse the PCI-E bus to control the HANIC. This would decrease the bandwidth dependency on the PCI-E slots and as well as the requirements on system memory. Packet processing latency due to transferring packets to and from the system memory would also be eliminated.

In another embodiment of the invention, HANICs can be programmed to filter packets for special operations, such as packets matching filters are applied certain set of network impairments meantime non matching ones are forwarded, or applied different set of impairments.

In another embodiment of the invention, HANIC can be used to generate packet streams with controllable packet content, and packet or bit rates. The rates can be implemented by setting “send time” of the packets.

In another embodiment of the invention, HANIC can be used to replay previously captured packets. Since in this case the packets are sent according to the actual packet receive times, replayed packets would preserve the original captured packets' transmission characteristics.

1. An apparatus for implementing wire speed packet network emulation, comprising one or more hardware accelerated network interface cards, hardware accelerated network interface card driver software, network emulation software and a host computer; said hardware accelerated network interface card has one or more network interfaces; said hardware accelerated network interface card uses packet reception, transmission and filtering logic programmed in Field Programmable Gate Array (FPGA), Application Specific Integrated Circuit (ASIC) or System on Chip (SOC) integrated circuit chips; said packet transmission is based on computed send times of the packets;

2. The apparatus as described in claim 1, wherein the wire speed is the maximum theoretical throughput of a network connection for smallest allowed packets. For example, for gigabit Ethernet connections, the wire speed is defined as 1.4 million packets per second for 64 byte packets.

3. The apparatus as described in claim 1, wherein hardware accelerated network interface card receives and stores the packets on host computers memory with direct memory access (DMA) method and does not generate traditional interrupt events while receiving packets; said packets are transfered from network to the memory and from memory to the network without any memory copy operation, (also known as zero copy).

4. The apparatus as described in claim 1, wherein the network emulation software generates network impairments, comprising packet latency, packet loss, bandwidth throttling, out-of-order packets, duplicate packets, packet fragmentation, jitter, accumulating and bursting packets, corrupting or modifying packets, queuing packets in any one direction of the packet traffic flow; said network emulation software accesses the packets in DMA via the hardware accelerated network interface card driver software and hardware registers.

5. The apparatus as described in claim 1, wherein for each packet, the transmission time occurs at previously computed send time of the packet; said send time is dynamically computed based on the system settings defined by the user.

6. The apparatus as described in claim 1, wherein the host computer has fast I/O card interfaces such as PCI-X, PCI-E, or SPI, wherein the hardware accelerated network interface cards are connected to these interfaces.

7. In one embodiment of the claim 1; said packets can optionally be stored in a computer memory located on the hardware accelerated network interface card; said packets would stay in the hardware accelerated network interface card and would not get transferred into the host computer memory system; said network emulation logic can optionally be programmed on FPGA, ASIC or SOC chips.

8. In another embodiment of the claim 1; said hardware accelerated network interface card can be used to generate custom packet streams of any packet size, content and packet or bit rate by using the feature of “transmission based on the packet send time”; said rate is up to wire speed.

9. In another embodiment of the claim 1; said hardware accelerated network interface card can be used to replay previously captured packets stored in host computer's volatile or non-volatile memory; said replaying is based on packets' receive time to preserve the packet timing; said replaying is up to wire speed.

10. In another embodiment of the claim 1; said hardware accelerated network interface card can use packet filtering to implement a set of network impairments on packets that match filters. Packets not matching the filters can be forwarded or applied different set of impairments.

11. A method for implementing wire speed packet network emulation, comprising one or more hardware accelerated network interface cards, driver software, network emulation software and a host computer; said hardware accelerated network interface card has one or more network interfaces; said hardware accelerated network interface card uses packet reception, transmission and filtering logic programmed in Field Programmable Gate Array (FPGA), Application Specific Integrated Circuit (ASIC) or System on Chip (SOC) integrated circuit chips; said packet transmission is based on computed send times of the packets;

12. The method as described in claim 11, wherein the wire speed is the maximum theoretical throughput of a network connection for smallest allowed packets. For example, for gigabit Ethernet connections, the wire speed is 1.4 million packets per second for 64 byte packets.

13. The apparatus as described in claim 11, wherein hardware accelerated network interface card receives and stores the packets on host computers memory with direct memory access (DMA) method and does not generate traditional interrupt events while receiving packets; said packets are transfered from network to the memory and from memory to the network without any memory copy operation, (also known as zero copy).

14. The method as described in claim 11, wherein the network emulation software generates network impairments, comprising packet latency, packet loss, bandwidth throttling, out-of-order packets, duplicate packets, packet fragmentation, jitter, accumulating and bursting packets, corrupting or modifying packets, queuing packets in any one direction of the packet traffic flow; said network emulation software accesses the packets in DMA via the hardware accelerated network interface card driver software and hardware registers.

15. The method as described in claim 11, wherein for each packet, the transmission time occurs at previously computed send time of the packet; said send time is dynamically computed based on the system settings defined by the user.

16. The method as described in claim 11, wherein the host computer has fast I/O card interface such as PCI-X, PCI-E, or SPI, wherein the hardware accelerated network interface cards are connected to these interfaces.

17. In one embodiment of the claim 11; said packets can optionally be stored in a computer memory located on the hardware accelerated network interface card; said packets would stay in the hardware accelerated network interface card and would not get transferred into the host computer memory system; said network emulation logic can optionally be programmed on FPGA, ASIC or SOC chips.

18. In another embodiment of the claim 11; said hardware accelerated network interface card can be used to generate custom packet streams of any packet size, content and packet or bit rate by using the feature of “transmission based on the packet send time”; said rate is up to wire speed.

19. In another embodiment of the claim 11; said hardware accelerated network interface card can be used to replay previously captured packets stored in host computer's volatile or non-volatile memory; said replaying is based on packets' receive time to preserve the packet timing; said replaying is up to wire speed.

20. In another embodiment of the claim 11; said hardware accelerated network interface card can use packet filtering to implement a set of network impairments on packets that match filters. Packets not matching the filters can be forwarded or applied different set of impairments.
